(19) United States
(12) Patent Application Publication
(10) Pub. No.: US 2022/0344925 A1
(43) Pub. Date: Oct. 27, 2022

(54) TOWER SOCKET

(71) Applicant: Wa Qigou (Guangzhou) Technology Co., Ltd., Guangzhou (CN)

(72) Inventor: WEN-KANG LI, Guangzhou (CN)

(21) Appl. No.: 17/722,576

(22) Filed: Apr. 18, 2022

(30) Foreign Application Priority Data
Apr. 27, 2021 (CN) 202110462234.8

(51) Int. Cl. H02G 11/02; H01R 13/70; H01R 13/717; H01R 24/76

(52) U.S. Cl. CPC H02G 11/02; H01R 13/70; H01R 13/717; H01R 24/76

(57) ABSTRACT

The present disclosure provides A tower socket, comprising a top cover, a housing, a base and a power line, two ends of the housing are respectively connected to the top cover and the base, the tower socket further comprises a rotating shaft, a rotating wheel and a conductive sheet, the rotating wheel is located in the base, and one end of the rotating shaft is connected to the top cover; the other end is connected to the rotating wheel, and a hole is provided on the base; the power line passes through the hole and can be wound on the rotating wheel; the power cord is electrically connected to a plurality of terminal on the rotating wheel, the rotation of the top cover can drive the rotating shaft to rotate the rotating wheel; the conductive sheet comprises a plurality of annular ring members, and the plurality of terminals are respectively in contact with the corresponding annular ring members, and are rotatable relative to an annular ring member of the conductive sheet; The part of the top cover of the present disclosure can rotate relative to the housing and the base, the rotating shaft drives the rotating wheel to rotate, and the power line of the tower socket connected to the rotating wheel is wound on the rotating wheel, so that the power wire is retracted into the base through the hole of the base, thereby avoiding the problem that the power line of the appliance inserted into the tower socket wound around the housing or the base, and it is also convenient to move the tower socket.

### RELATED APPLICATIONS

This application claims the benefit of priority to Chinese Patent Application Number 202110462234.8 filed on Apr. 27, 2021 in the China National Intellectual Property Administration. The entire contents of the above-identified application are hereby incorporated by reference.

### TECHNICAL FIELD

The disclosure relates to the technical field of sockets, and particularly relates to a tower socket.

### BACKGROUND

Existing tower type socket, also known as vertical socket, includes a body and a power line connected with the body. In the process of retracting its own power line, due to the rotation of the body, the power lines of other electrical appliances inserted in the connection hole on the body become wound around the body, resulting in poor use experience.

### BRIEF DESCRIPTION OF DRAWINGS

FIG. 1 is a three-dimensional structural diagram showing a tower socket provided by an embodiment of the present disclosure.

FIG. 2 is a three-dimensional structural diagram of another angle of the tower socket shown in FIG. 1.

FIG. 3 is a partial three-dimensional structural diagram of the tower socket shown in FIG. 1.

FIG. 4 is an exploded view of a top cover shown in FIG. 3.

FIG. 5 is an exploded view of another angle of the top cover shown in FIG. 4.

FIG. 6 is a three-dimensional structural diagram of a rotating wheel and a conductive sheet shown in FIG. 3.

FIG. 7 is a sectional view of the tower socket shown in FIG. 1.

FIG. 8 is a three-dimensional schematic diagram of a rotating wheel provided by another embodiment of the present disclosure.

### The following detailed description further describes the present disclosure with reference to the accompanying drawings.

### DETAILED DESCRIPTION

The following will clearly and completely describe the technical solutions in the embodiments of the present disclosure with reference to the accompanying drawings in the embodiments of the present disclosure. Obviously, the described embodiments are only a part of the implementation of the present disclosure, not all of them. Based on the embodiments of the present disclosure, all other embodiments obtained by those of ordinary skill in the art without creative work shall fall within the scope of protection of the present disclosure.

It should be noted that when a component is referred to as being “fixed to” another component, it can be directly fixed on the other component or a centered component may also exist. When a component is considered to be “connected” to another component, it can be directly connected to the other component or there may be a centered component at the same time. When a component is considered to be “installed on” another component, it can be directly installed on another component or a centered component may exist at the same time. The terms “vertical”, “horizontal”, “left”, “right” and similar expressions used herein are for illustrative purposes only.

Unless otherwise defined, all technical and scientific terms used herein have the same meaning as commonly understood by those skilled in the technical field of the present disclosure. The terminology used in the description of the disclosure herein is only for the purpose of describing specific embodiments, and is not intended to limit the disclosure. The term “and/or” as used herein includes any and all combinations of one or more related listed items.

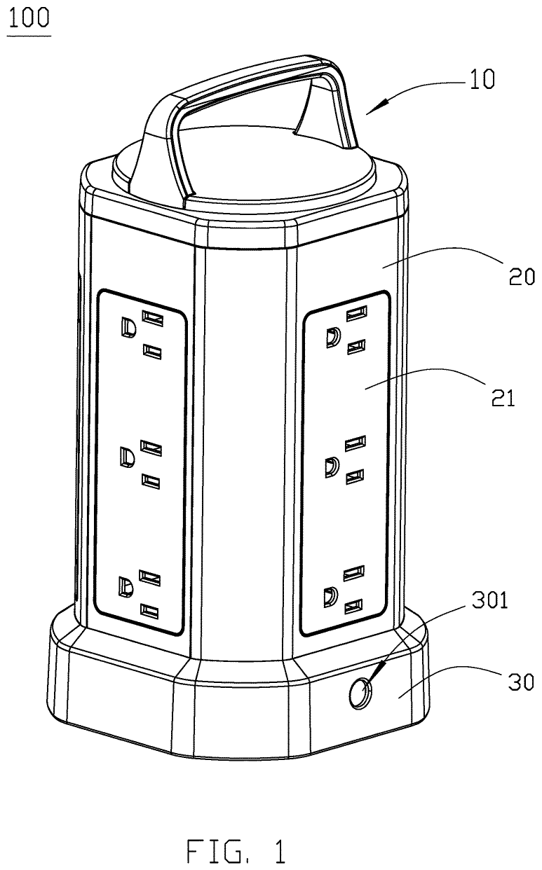

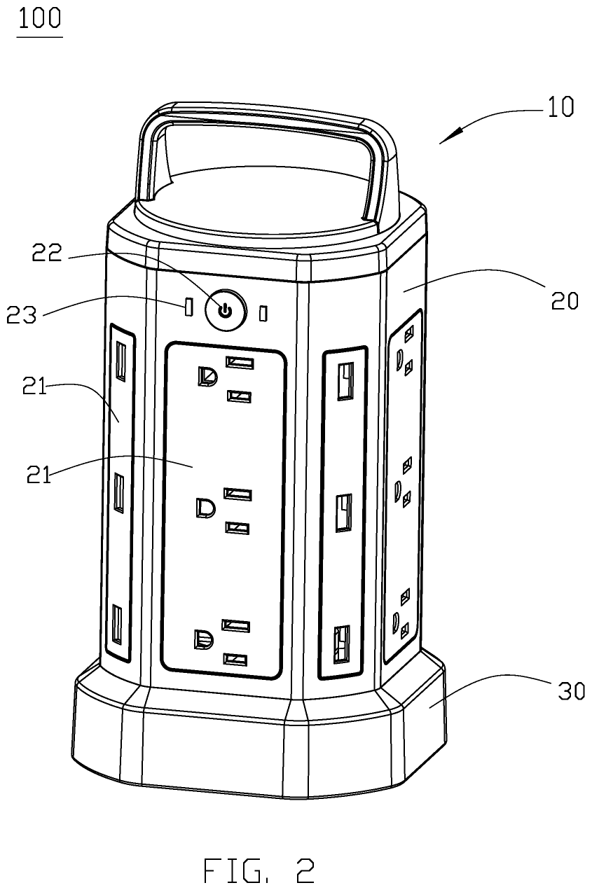

Referring to FIG. 1 and FIG. 2, an embodiment of the present disclosure provides a tower socket 100 having a prismatic shape. The tower socket 100 includes a top cover 10, a housing 20, a base 30, and a power cord (not shown). The housing 20 is located between the top cover 10 and the base 30, and two ends of the housing 20 are respectively connected to the top cover 10 and the base 30. A through hole 301 is provided on a side surface of the base 30, and the power cord passes through the hole 301. The part of the top cover 10 may rotate relative to the housing 20 and the base 30, so that the power line is retracted back into the base 30 through the hole 301, thereby avoiding the problem that the power cord of the appliance inserted into the tower socket 100 wound around the housing 20 or the base 30.

Referring to FIG. 1 and FIG. 2, in the present disclosure, the housing 20 has an octagonal prism shape. In other embodiments, as long as the housing 20 can define a tower shaped space. A plurality of socket panels 21 are arranged on the housing 20, and a plurality of three-hole jacks and/or USB jacks are arranged on the socket panels 21 to supply power to different electrical appliances. It can be understood that the three-hole jack may be inserted by either the two-prong power plug or the three-prong power plug.

Referring to FIG. 2, the housing 20 is also provided with a power switch 22 and an indicator 23. It can be understood that the power switch 22 is used to control the on and off of the power supply of the tower socket 100, and the indicator 23 is used to indicate the surge protection status and/or the grounding status.

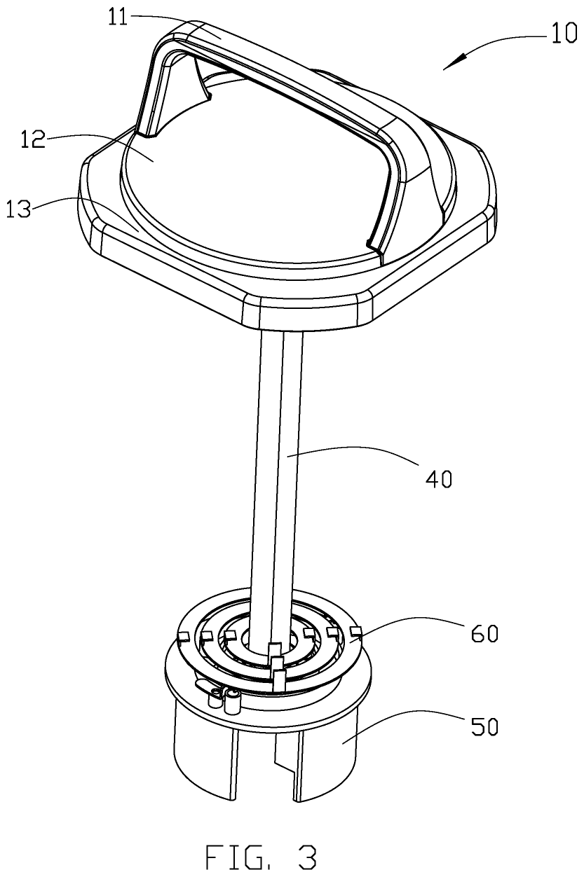

FIG. 3 is a partial three-dimensional schematic diagram of the tower socket 100 of the present disclosure. Referring to FIG. 3, the tower socket 100 also includes a rotating shaft 40, a rotating wheel 50 and a conductive sheet 60. It can be understood that in FIG. 3, in order to more clearly express the top cover 10, the rotating shaft 40, the rotating wheel 50 and the conductive sheet 60, a part of the housing 20 and the base 30 is not shown, and the components such as circuits, transformers and docking devices generally included in the socket are not shown. In this embodiment, one end of the rotating shaft 40 is connected with the top cover 10 and the other end is connected with the rotating wheel 50. The top cover 10 rotates relative to the housing 20 and the base 30 to drive the rotating shaft 40 to rotate, and to further drive the rotating wheel 50 to rotate.

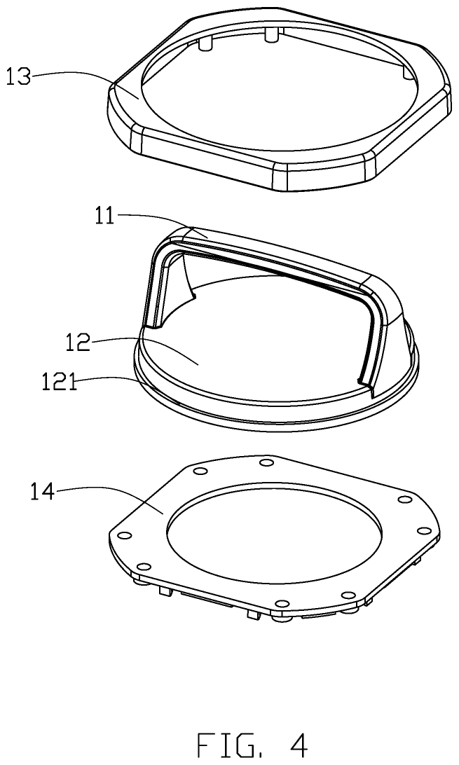

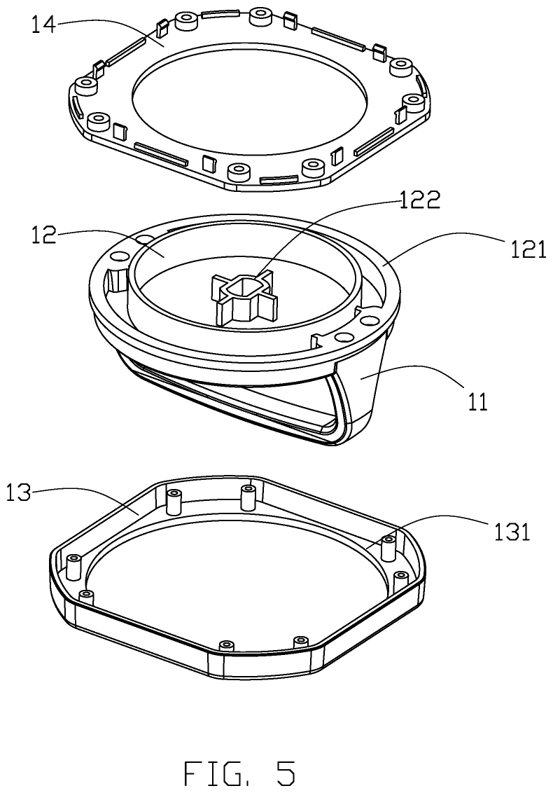

Referring to FIGS. 3 to 5, FIG. 4 is an exploded view of the top cover shown in FIG. 3, and FIG. 5 is an exploded view of another angle of the top cover shown in FIG. 4. The top cover 10 comprises a handle 11, a rotating cover 12, a fixing cover 13 and a bracket 14. The handle 11 generally has an ‘n’ shape, and includes a handle portion and a connecting portion respectively connected to two ends of the handle portion. The two connecting portions are respectively connected to the rotary cover 12.

In the present disclosure, the rotating cover 12 is substantially disc-shaped, and the peripheral edge protrudes from a flange 121. The fixing cover 13 is substantially annular and includes a cover edge 131. The rotating cover 12 is located between the fixing cover 13 and the bracket 14, and the cover edge 131 of the fixing cover 13 at least covers the flange 121 of the rotating cover 12. The fixing cover 13 is fixedly connected to the up-down direction by fixing cover 13 and the bracket 14, but the rotation movement with the vertical direction as the axis is not restricted. In the present disclosure, the bracket 14 is detachably fastened to the housing 20, but is not limited thereto, and may be fixedly connected to the housing 20.

A hole is formed in the bracket 14, and the rotating shaft 40 is penetrated into the through hole. A first fixing portion 122 is disposed inside the rotating cover 12, that is, on a side away from the handle 11. In this embodiment, the cross-sectional shape of the rotating shaft 40 is not circular, and the two opposite parts are cut (that is, its four sides are a pair of line segments and a pair of circular arcs), but it is not limited to this. It can be understood that the cross- sectional shape of the rotating shaft 40 can be triangle, rectangle, square, etc. As long as it is not a circle that cannot be driven to rotate. The first fixing portion 122 forms an accommodating space adapted to the cross-sectional shape of the rotating shaft 40. One end of the rotating shaft 40 is inserted into the first fixing portion 122, so that the rotating shaft 40 can be rotated when the rotating cover 12 rotates.

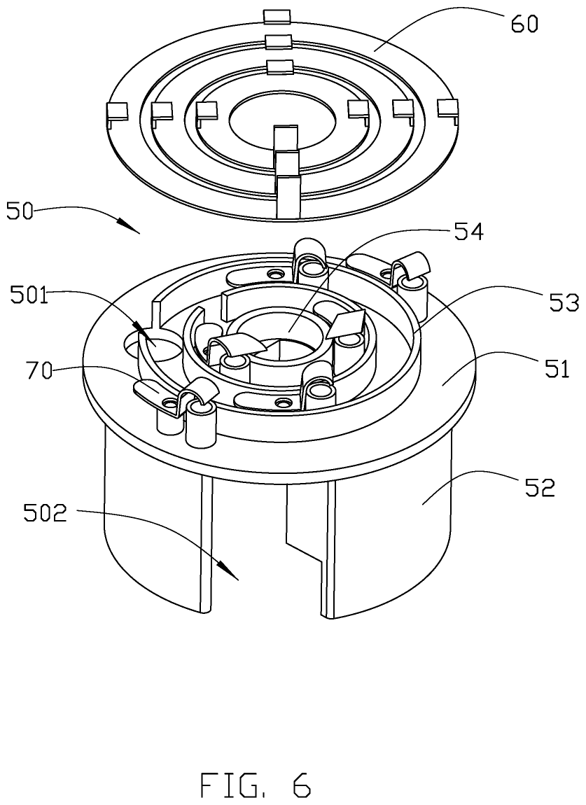

Referring to FIG. 6, FIG. 6 is a three-dimensional structural diagram of the rotating wheel 50 and the conductive sheet 60. The rotating wheel 50 is located in the base 30, and is located at a side of the rotating shaft 40 away from the top cover 10. The rotating wheel 50 includes a top plate 51 and a sidewall 52, which are connected to each other. The top plate 51 is substantially circular, and the sidewall 52 is substantially hollow cylindrical. The top plate 51 is connected to one end of the sidewall 52.

In the present disclosure, a second fixing portion 54 is protruded from the sidewall 52 of the top plate 51. One end of the rotating shaft 40 is inserted into the second fixing portion 54, so that when the rotating shaft 40 rotates, the rotating wheel 50 rotates.

In the present disclosure, the conductive sheet 60 is three concentric rings. The conductive sheet 60 is located on a side of the rotating wheel 50 close to the top cover 10, and is electrically connected to a circuit board (not shown). Two spacers 53 are arranged on one surface of the top plate 51 away from the sidewall 52 corresponding to the conductive sheet 60. The two spacers 53 divide a face of the top plate 51 away from the sidewall 52 into three concentric rings corresponding to the conductive sheet 60. That is, the two spacers 53 and the second fixing portion 54 form three concentric rings corresponding to the three conductive sheets 60. In the present disclosure, a plurality of terminals 70 are fixed on one or both sides of the spacer 53 on the top plate 51. The plurality of terminals 70 are disposed in a staggered manner between one of the two spacers 53 and the second fixing portion 54, between the two spacers 53 and the other spacer 53 away from the second fixing portion 54. A portion of the plurality of terminals 70 protrudes from the top of the spacer 53 and the second fixing portion 54 to facilitate contact with the conductive sheet 60. The plurality of terminals 70 are respectively in contact with the conductive sheet 60. The plurality of terminals 70 are also electrically connected with the power line (not shown) of the tower socket 100, so that when the rotating wheel 50 rotates, the plurality of terminals 70 also rotate relative to the conductive sheet 60, but the plurality of terminals 70 can always contact the circular conductive sheet 60, so that the path of the circuit will not be broken due to the rotation of the rotating wheel 50. In some embodiments, the second metal portion is not in contact with the wall surface of the first avoiding cavity, and the second metal portion is not in contact with the wall surface of the second avoiding cavity.

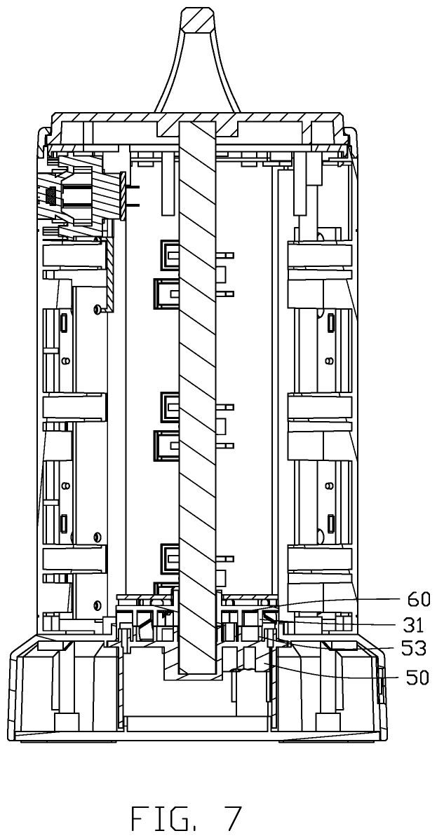

In addition, as shown in FIG. 7, the side of the base 30 facing the rotating wheel 50 is provided with a plurality of protrusions 31 corresponding to the spacer 53. A space for accommodating the corresponding conductive sheet 60 is formed between every two protrusions 31. Except for the outermost conductive sheet 60, each conductive sheet 60 of the inner ring is located between the two protrusions 31, respectively. The spacer 53 is arranged corresponding to the protrusions 31, so as to separate the plurality of conductive sheets 60, so that the plurality of conductive sheets 60 are insulated, so as to avoid cross circuits and the like. At the same time, the multiple terminals 70 are separated to insulate the multiple terminals 70. The spacer 53 is arranged corresponding to the protrusions 31, so as to separate the plurality of conductive sheets 60, so that the plurality of conductive sheets 60 are insulated, so as to avoid cross circuits and the like. At the same time, the spacer 53 and the protrusions 31 provided correspondingly also separate the plurality of terminals 70 and insulate the plurality of terminals 70.

As described above, in the present disclosure, the conductive sheet 60 includes three concentric circular rings, but is not limited thereto. It can be understood that in other embodiments, the circular rings of the conductive sheet 60 may be arranged as required.

In the present disclosure, the material of the conductive sheet 60 is copper, but is not limited thereto as long as it is a conductive material.

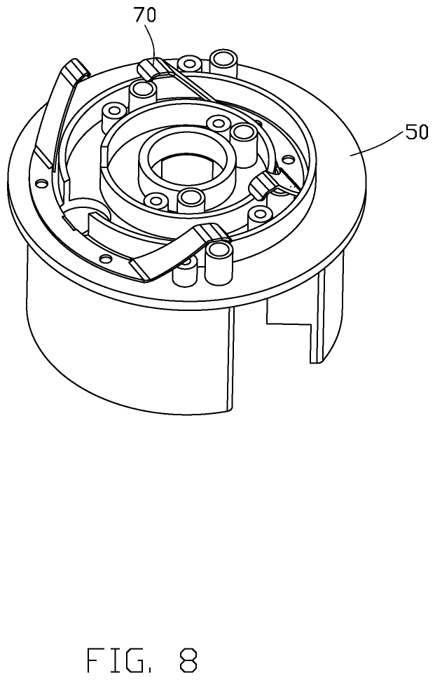

In addition, as shown in FIG. 8, both ends of the terminals 70 may protrude from the top of the spacer 53.

The top plate 51 is provided with a perforation 501. Specifically, in this embodiment, the perforation 501 is close to the outermost spacer 53. The power cord of the tower socket 100 is connected to a plurality of terminals 70 on the top plate 51 and passes through the perforation 501. An opening 502 is provided on the sidewall 52. The power cord of the tower socket 100 passes through the perforation 501 and also passes through the opening 502, and can be wound on the sidewall 52. In the present disclosure, the opening 502 has a rectangular shape, but is not limited thereto. It can be understood that in other embodiments, the opening 502 may have other shapes as long as the opening 502 can pass through the power supply line.

Preferably, the top plate 51 extends outwardly from the sidewall 52 to limit the position at which the power cords of the tower socket 100 are wound on the sidewall 52.

When in use, the user holds the handle and rotates the handle to drive the rotating cover 12 to rotate, the rotating cover 12 drives the rotating shaft 40 to rotate, and the rotating shaft 40 drives the rotating wheel 50 to rotate, so that the power cord of the tower socket 100 is wound on the sidewall 52. It can be understood that from the user's point of view, the power cord is retracted into the base 30 through the hole 301 to avoid the problem that the power line of the electrical appliance inserted into the tower socket 100 wound on the housing 20 or the base 30. In addition, the user can lift the whole tower socket 100 by holding the handle. After the power cord has been retracted, the power cord will not be dragged on the ground or desktop, thus facilitating the movement of the tower socket 100.

Compared with the prior art, the part of the top cover 10 of the application can rotate relative to the housing 20 and the base 30. The rotating shaft 40 drives the rotating wheel 50 to rotate, and the power line of the tower socket 100 is wound on the rotating wheel 50, so that the power line is retracted into the base 30 through the hole 301 of the base 30, so as to avoid the problem that the power line of the electrical appliance inserted into the tower socket 100 wound on the housing 20 or the base 30. It is also convenient to move the tower socket 100.

The present application provides a tower socket, comprising a top cover, a housing, a base and a power line, two ends of the housing are respectively connected to the top cover and the base, the tower socket further comprises a rotating shaft, a rotating wheel and a conductive sheet, the rotating wheel is located in the base, and one end of the rotating shaft is connected to the top cover; the other end is connected to the rotating wheel, and a hole is provided on the base, the power line passes through the hole and can be wound on the rotating wheel, the power line is electrically connected to a plurality of terminals on the rotating wheel, the rotation of the top cover can drive the rotating shaft to rotate the rotating wheel, the conductive sheet comprises a plurality of annular ring members, and the plurality of terminals are respectively in contact with the corresponding annular ring members, and are rotatable relative to an annular ring member of the conductive sheet.

Compared with the prior art, the part of the top cover of the present disclosure can rotate relative to the housing and the base, the rotating shaft drives the rotating wheel to rotate, and the power line of the tower socket connected to the rotating wheel is wound on the rotating wheel, so that the power wire is recovered into the base through the hole of the base, thereby avoiding the problem that the power line of the appliance inserted into the tower socket wound around the housing or the base, and it is also convenient to move the tower socket.

It can be understood that for those skilled in the art, other corresponding changes and deformations can be made according to the technical concept of the application, and all these changes and deformations should belong to the protection scope of the claims of the application.

What is claimed is:

1. A tower socket, comprising a top cover, a housing, a base and a power line, two ends of the housing are respectively connected to the top cover and the base, wherein
the tower socket further comprises a rotating shaft, a rotating wheel and a conductive sheet, the rotating wheel is located in the base, and one end of the rotating shaft is connected to the top cover; the other end is connected to the rotating wheel, and a hole is provided on the base, the power line extends through the hole and can be wound on the rotating wheel, the power cord is electrically connected to a plurality of terminal on the rotating wheel, the top cover is rotatable to drive the rotating shaft to rotate the rotating wheel, the conductive sheet comprises a plurality of annular ring members, and the plurality of terminals are respectively in contact with a corresponding one of the plurality of annular ring members, and are rotatable relative to an annular ring member of the conductive sheet.

2. The tower socket according to claim 1, wherein the rotating wheel comprises a top plate and a sidewall which are connected to each other, the top plate of the rotating wheel is provided with a perforation, the sidewall of the rotating wheel is provided with an opening, the plurality of terminals are fixed on the top plate, and the power cord extends through the perforation and the opening.

3. The tower socket according to claim 2, wherein the top cover comprises a handle, a rotating cover, a fixing cover and a bracket, the bracket is connected to the housing, the handle is connected to the rotating cover, the fixing cover is connected to the bracket, and the rotating cover is rotatably sandwiched between the fixing cover and the bracket.

4. The tower socket according to claim 3, wherein a first fixing portion is provided on a side of the rotating cover away from the handle, and a second fixing portion is provided on the rotating wheel, one end of the rotating shaft is inserted into the first fixing portion, and the other end is inserted into the second fixing portion, and a cross section of the rotating shaft is non- circular.

5. The tower socket according to claim 4, wherein a plurality of spacers are arranged on one side of the top plate away from the sidewall corresponding to the conductive sheet.

6. The tower socket according to claim 5, wherein a portion of the plurality of terminals protrudes from the top of the spacer and the second fixing portion.

7. The tower socket according to claim 6, wherein the plurality of terminals are staggered between one of the two spacers and the second fixing portion, between the two spacers and the outside of the spacer away from the second fixing portion.

8. The tower socket according to claim 5, wherein the side of the base facing the rotating wheel is provided with a plurality of protrusions corresponding to the spacer, a space for accommodating the corresponding conductive sheet is formed between the every two protrusions.

9. The tower socket according to claim 6, wherein the two ends of the plurality of terminals protrude from the top of the spacer.

10. The tower socket according to claim 1, wherein the housing is provided with a plurality of socket panels.

11. The tower socket according to claim 1, wherein the housing is provided with a power switch and an indicator.

12. The tower socket according to claim 1, wherein the conductive sheet is made of copper.
